(19) United States
(12) Patent Application Publication
(10) Pub. No.: US 2013/0260105 A1
(43) Pub. Date: Oct. 3, 2013

(54) GLASS SUBSTRATE FOR DISPLAY DEVICE AND METHOD OF MANUFACTURING THE SAME

(71) Applicants: Yong-Su LEE, Hwaseong-si (KR); Hyang-Shik KONG, Seongnam-si (KR); Yoon-Ho KHANG, Yongin-si (KR); Se-Hwan YU, Seoul (KR)

(72) Inventors: Yong-Su LEE, Hwaseong-si (KR); Hyang-Shik KONG, Seongnam-si (KR); Yoon-Ho KHANG, Yongin-si (KR); Se-Hwan YU, Seoul (KR)

(73) Assignee: SAMSUNG DISPLAY CO., LTD., Yongin-City (KR)

(21) Appl. No.: 13/596,421

(22) Filed: Aug. 28, 2012

(30) Foreign Application Priority Data
Mar. 30, 2012 (KR) 10-2012-0032860

(51) Int. Cl. B32B 3/02; C03C 21/00; B32B 17/00

(52) U.S. Cl. 428/192; 65/30.14; 65/28

(57) ABSTRACT

In a method of manufacturing a glass plate for a display device, a protection film is formed on a mother glass plate. The protection film is patterned to form a protection film pattern which prevents ion exchange. Chemically strengthening the mother glass plate includes exchanging alkaline ions of the mother glass plate including the protection film pattern are exchanged with metal ions of a molten salt to form a first chemically strengthened portion, a non-strengthened portion and a second chemically strengthened portion. The upper surface of the protection film pattern is cut in the scribe line area to separate the glass plate at the non-strengthened portion of the mother glass plate, from the mother glass plate.

This application claims priority to Korean Patent Application No. 10-2012-0032860, filed on Mar. 30, 2012 and all the benefits accruing therefrom under 35 U.S.C. §119, the content of which, in its entirety, is herein incorporated by reference.

### BACKGROUND

1. Field

Exemplary embodiments of the invention relate to a glass substrate for a display device and a method of manufacturing the glass substrate for a display device. More particularly, exemplary embodiments of the invention relate to a chemically strengthened glass substrate for a display device and a method of manufacturing the chemically strengthened glass substrate for a display device.

2. Description of the Related Art

A chemically strengthened glass substrate is used so that the glass substrate has improved surface hardness and high display resolution. Particularly, in a case of a display device including a display module which uses a touch panel, the chemically strengthened glass substrate is mainly used to protect the touch panel.

The chemically strengthened glass substrate is formed separately through cutting a mother glass plate into a cell unit or a plurality of cell units. However, since the chemically strengthened mother glass plate has an enhanced surface hardness, cutting may be difficult. Generally, a laser cutting is used to cut the mother glass plate. However, in the laser cutting, a thermal stress is generated in the mother glass plate by sectional melting and quick freezing and the mother glass plate may be damaged by external shocks. Further, the laser cutting increases a manufacturing cost of a display device and/or a display module.

### SUMMARY

One or more exemplary embodiments of the invention provide a strengthened glass substrate for a display device manufactured at a reduced cost.

One or more exemplary embodiments of the invention also provide a method of manufacturing the strengthened glass substrate for the display device without incurring damage such as a crack in the strengthened glass substrate, and at reduced cost.

In an exemplary embodiment of a glass substrate for a display device according to the invention, the glass substrate for a display device includes a glass plate and a protection film pattern. The glass plate includes a first chemically strengthened portion, a non-strengthened portion and a second chemically strengthened portion. The first chemically strengthened portion is on an upper surface of the glass plate. The non-strengthened portion is on a periphery of the upper surface of the glass plate. The second chemically strengthened portion is on a lower surface of the glass plate. The protection film pattern is on the non-strengthened portion of the glass plate.

In the exemplary embodiment, the protection film pattern may include at least one selected from silicon nitride, silicon oxide, aluminum oxide, molybdenum and an alloy of molybdenum-tungsten.

In the exemplary embodiment, the protection film pattern may have a thickness of about 1,000 angstroms (Å) to about 10,000 angstroms (Å).

In an exemplary embodiment of a method of manufacturing the glass substrate for a display device according to the invention, a protection film is formed on a mother glass plate. The protection film is patterned to form a protection film pattern which prevents ion exchange. Chemically strengthening the mother glass plate includes exchanging alkaline ions of the mother glass plate including the protection film pattern with metal ions of a molten salt to form a first chemically strengthened portion, a non-strengthened portion and a second chemically strengthened portion. The first chemically strengthened portion is formed on an upper surface of the mother glass plate, the non-strengthened portion being formed on a portion of the mother glass plate under the protection film pattern. The second chemically strengthened portion is formed on a lower surface of the mother glass plate. The upper surface of the protection film pattern is cut to separate the glass plate at the non-strengthened portion of the mother glass plate, from the mother glass plate.

In the exemplary embodiment, the protection film pattern may be formed by using at least one selected from silicon nitride, silicon oxide, aluminum oxide, molybdenum and an alloy of molybdenum-tungsten

In the exemplary embodiment, the protection film includes at least one selected from silicon nitride, silicon oxide and aluminum oxide, and the forming the protection film pattern includes dry etching the protection film to form the protection film pattern.

In the exemplary embodiment, the protection film includes one selected from molybdenum and an alloy of molybdenum-tungsten, and the forming the protection film pattern includes wet etching the protection film to form the protection film pattern.

In the exemplary embodiment, the protection film pattern may be formed at a thickness of about 1,000 Å to about 10,000 Å.

In the exemplary embodiment, the cutting an upper surface of the protection film pattern is performed in a cutting margin, and a width of the protection film pattern may be greater than the cutting margin.

In the exemplary embodiment, the molten salt includes a salt of potassium nitrate, and the chemically strengthening the mother glass plate may include soaking the mother glass plate including the protection film pattern in the molten salt at a temperature of about 400 degree Celsius (° C.) to about 450° C. for about 30 minutes to about 2 hours, to form a compressive stress layer on the upper and lower surfaces of the mother glass plate. The compressive stress layer may be formed by substituting alkaline ions of the mother glass plate with potassium ions of the molten salt.

In the exemplary embodiment, a potassium ion concentration of the first and second chemically strengthened portions of the mother glass plate may be higher than a potassium ion concentration of the non-strengthened portion of the mother glass plate.

In the exemplary embodiment, the method may further include forming a circuit pattern including a sensing pattern, on the upper surface of the chemically strengthened mother glass plate.

In an exemplary embodiment, the cutting an upper surface of protection film pattern may be performed through a wheel cutting process.

In the exemplary embodiment, the wheel cutting process may include moving a scroll wheel onto the protection film pattern to generate a crack on the mother glass plate and applying a force to the cracked mother glass plate to separate the glass plate from the mother glass plate.

In the exemplary embodiment, the method may further include polishing an edge of the separated glass plate after the cutting an upper surface of the protection film pattern.

In the exemplary embodiment, the polishing an edge of the separated glass plate may remove an entire of the protection film pattern.

In an exemplary method of manufacturing the glass substrate for display according to the invention, a circuit pattern is formed on a first mother glass plate. A protection film is formed on a second mother glass plate. The protection film is patterned to form a protection film pattern which prevents ion exchange. Chemically strengthening the second mother glass plate includes exchanging alkaline ions of the second mother glass plate including the protection film pattern with metal ions of a molten salt to form a first chemically strengthened portion, a non-strengthened portion and a second chemically strengthened portion. The first chemically strengthened portion is formed on an upper surface of the mother glass plate. The non-strengthened portion is formed on a lower surface of the protection film pattern. The second chemically strengthened portion is formed on a lower surface of the mother glass plate. The second chemically strengthened portion of the second mother glass plate is combined with the upper surface of the first mother glass plate to form a laminated glass plate, and an upper surface of protection film pattern of the second mother glass plate is cut to separate the first and second mother glass plates at the non-strengthened portion of the second mother glass plate, from the laminated glass plate.

In the exemplary embodiment, the protection film may include at least one selected from silicon nitride, silicon oxide, aluminum oxide, molybdenum and an alloy of molybdenum-tungsten.

In the exemplary embodiment, the protection film may be formed at a thickness of about 1,000 Å to about 10,000 Å.

In the exemplary embodiment, the cutting an upper surface of protection film pattern may be performed by a wheel cutting process.

According to one or more embodiments of a glass substrate for a display device and method of manufacturing the glass substrate for a display device, the glass substrate for display device uses the chemically strengthened glass plate and is manufactured through wheel cutting at the non-strengthened portion of the protection film pattern. Therefore, manufacturing cost is decreased, and the glass plate is strengthened.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is a plan view illustrating an exemplary embodiment of a glass substrate for a display device according to the invention;

FIG. 2 is a cross-sectional view illustrating the glass substrate for a display device of FIG. 1;

FIGS. 3A to 3E are cross-sectional views illustrating an exemplary embodiment of a method of manufacturing the glass substrate for a display device of FIGS. 1 and 2;

FIG. 4 is a perspective view illustrating an exemplary embodiment of a chemically strengthened mother glass plate according to the invention;

FIG. 5 is a cross-sectional view illustrating another exemplary embodiment of a glass substrate for a display device according to the invention;

FIG. 6 is a cross-sectional view illustrating still another exemplary embodiment of a glass substrate for a display device according to the invention;

FIG. 7 is a cross-sectional view illustrating an exemplary embodiment of method of manufacturing the glass substrate for a display device of FIG. 6;

FIG. 8 is a plan view illustrating further still another exemplary embodiment of a glass substrate for a display device according to the invention;

FIGS. 9A to 9D are plan views illustrating an exemplary embodiment of a method of manufacturing the glass substrate for a display device of FIG. 8;

FIG. 10 is a exploded perspective view illustrating an exemplary embodiment of a display module including a glass substrate according to the invention;

FIG. 11 is a exploded perspective view illustrating another exemplary embodiment of a display module including a glass substrate according to the invention; and

FIGS. 12A to 12E are cross-sectional views illustrating an exemplary embodiment of a method of manufacturing the display module of FIG. 11.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “under” or “lower” relative to other elements or features would then be oriented “above” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be explained in detail with reference to the accompanying drawings.

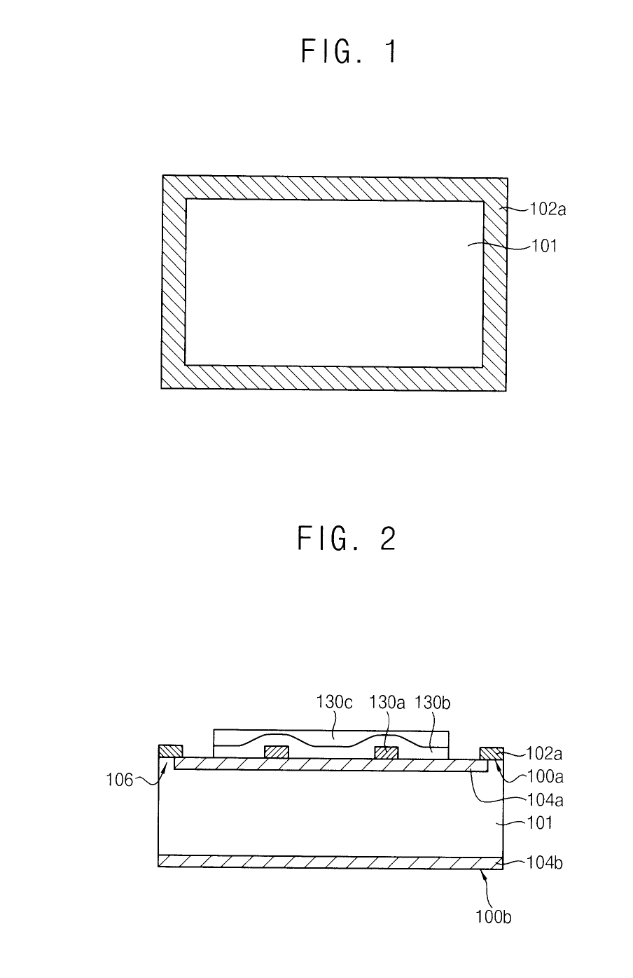

FIG. 1 is a plan view illustrating an exemplary embodiment of a glass substrate for a display device according to the invention. FIG. 2 is a cross-sectional view illustrating the glass substrate for a display device of FIG. 1.

Referring to FIGS. 1 and 2, the glass substrate includes a glass plate 101 and a protection film pattern 102a. The protection film pattern 102a is disposed on an upper surface 100a and at edges of the glass plate 101.

The glass plate 101 may include a soda-lime glass, a soda-lime glass, etc. but is not limited thereto or thereby. In one exemplary embodiment, the glass plate 101 may include Gorilla® glass (trade name, available from Corning Incorporated, U.S.A.) having a hardness greater than the soda-lime glass.

The glass plate 101 includes a first chemically strengthened portion 104a, a non-strengthened portion 106 and a second chemically strengthened portion 104b. The first chemically strengthened portion 104a is under the upper surface 100a of the glass plate 101. An upper surface of the first chemically strengthened portion 104a may be coplanar with the upper surface 100a of the glass plate 101, but is not limited thereto or thereby. In a plan view, outer edges or boundaries of the first chemically strengthened portion 104a may be spaced apart from the outer edges of the glass plate 101.

The non-strengthened portion 106 is on a portion of the outer edge of the upper surface 100a of the glass plate 101. In a plan view, the non-strengthened portion 106 may surround the first chemically strengthened portion 104a, and outer edges or boundaries of the non-strengthened portion 106 may be coplanar with side surfaces of a remainder of the glass plate 101.

The second chemically strengthened portion 104b is under a lower surface 100b of the glass plate 101. In a plan view, outer edges or boundaries of the second chemically strengthened portion 104b may be substantially coplanar with the side surfaces of the glass plate 101 and/or outer edges of the non-strengthened portion 106.

As illustrated in FIG. 2, the non-strengthened portion 106 of the glass plate 101 under and overlapping the protection film pattern 102a.

Alkaline ions (e.g., sodium ions) included in the base material of the glass plate 101 may be substituted with potassium ions in the first and second chemically strengthened portions 104a and 104b. A compressive stress is formed in the first and second chemically strengthened portions 104a and 104b, so that a surface hardness of the first and second chemically strengthened portions 104a are 104b is increased. Also, a tensile stress is generated in an interior of the glass plate between the first chemically strengthened portion 104a and the second chemically strengthened portion 104b.

Surface hardness of the non-strengthened portion 106 of the glass plate 101 is not increased since ions of the base material of the glass plate are not exchanged. In one exemplary embodiment, for example, the non-strengthened portion 106 is not doped, or a potassium ion concentration of the non-strengthened portion 106 is lower than that of the first and second chemically strengthened portions 104a and 104b. That is, the potassium ion concentration of the first and second chemically strengthened portions 104a and 104b may be higher than that of the non-strengthened portion 106.

A circuit pattern of the display device or of a display module may be on a surface of the first chemically strengthened portion 104a of the glass plate 101. The circuit pattern may include a sensing pattern 130a, a insulating layer 130b and a ground electrode layer 130c, but is not limited thereto or thereby. In one exemplary embodiment, for example, the sensing pattern 130a may include a transparent glass electrode.

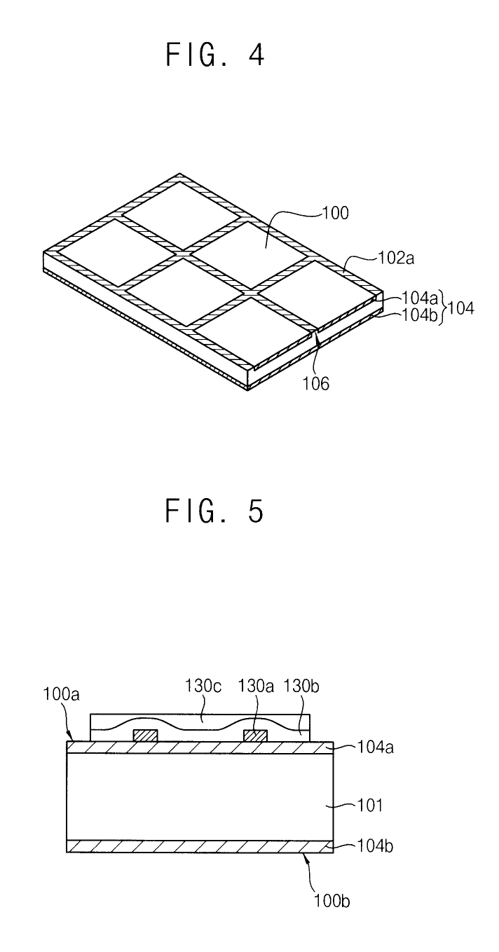

The protection film pattern 102a reduces or effectively prevents ion exchange in the base material and/or the non-strengthened portion 106 of the glass plate 101. When the glass plate 101 is a portion of a mother glass plate 100 (see FIG. 4), the protection film pattern 102a may also protects the glass plate 101 when the mother glass plate 100 is cut in a manufacturing process. The protection film pattern 102a may include an inorganic insulating layer, a metal layer, etc., but is not limited thereto or thereby The protection film pattern 102a may include a material having various characteristics such as a high surface hardness, a high corrosion resistance, a high erosion resistance, an eco-friendly material, etc. The protection film pattern 102a may include silicon nitride, silicon oxide, aluminum oxide, molybdenum, an alloy of molybdenum-tungsten, etc. In one exemplary embodiment, for example, the protection film pattern 102a may include silicon nitride or silicon oxide.

As discussed above, the protection film pattern 102a reduces or effectively prevents ion exchange. A thickness of the protection film pattern 102a may be adjusted in consideration of a cutting process, for example, so that the mother glass plate 100 can be easily cut by a cutting wheel during a manufacturing process. Where the protection film pattern 102a has a thickness less than about 1,000 angstroms (Å), the protection film pattern 102a may not prevent the ion exchange. Also, where the protection film pattern 102a has a thickness more than about 10,000 Å, the protection film pattern 102a may not be easily cut during the manufacturing process. Therefore, the protection film pattern 102a may have a thickness of about 1,000 Å to about 10,000 Å, but is not limited thereto or thereby.

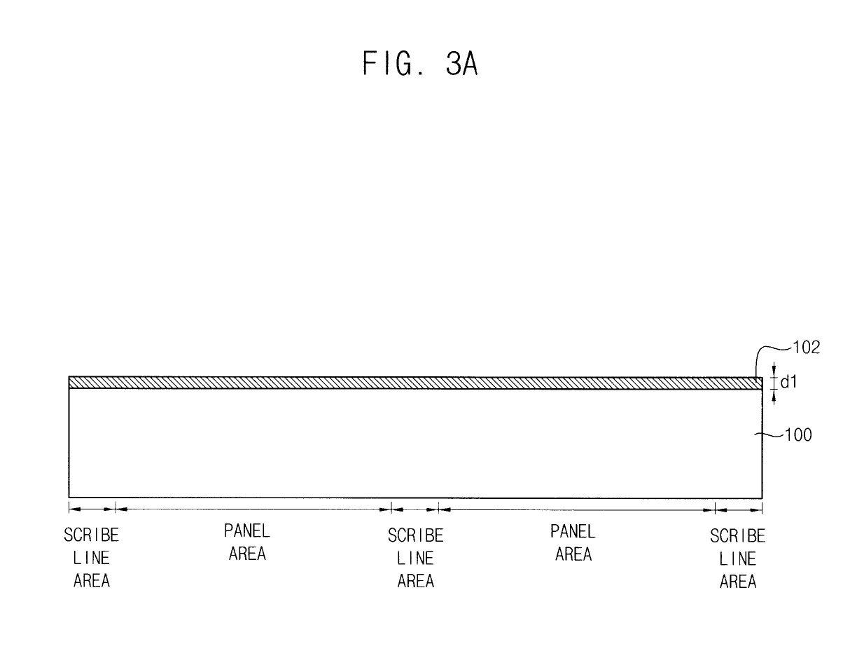

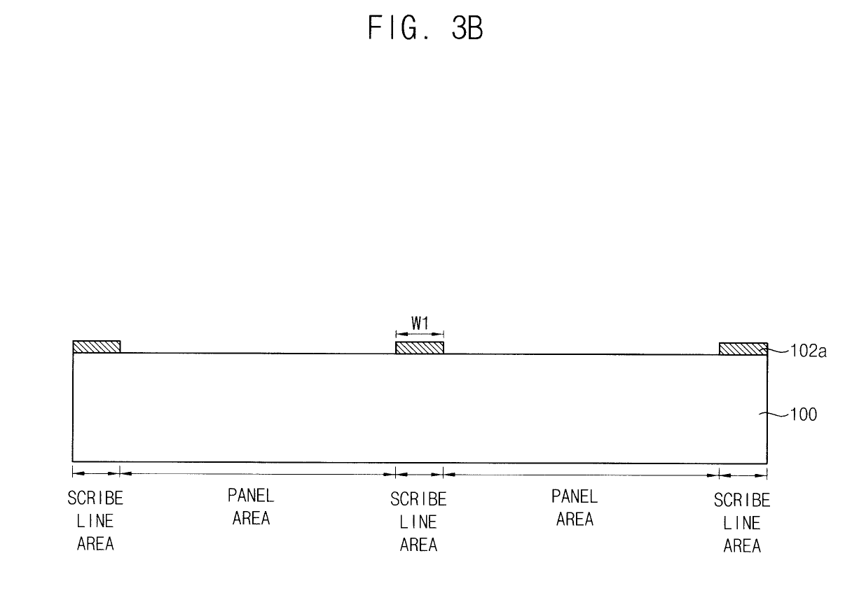

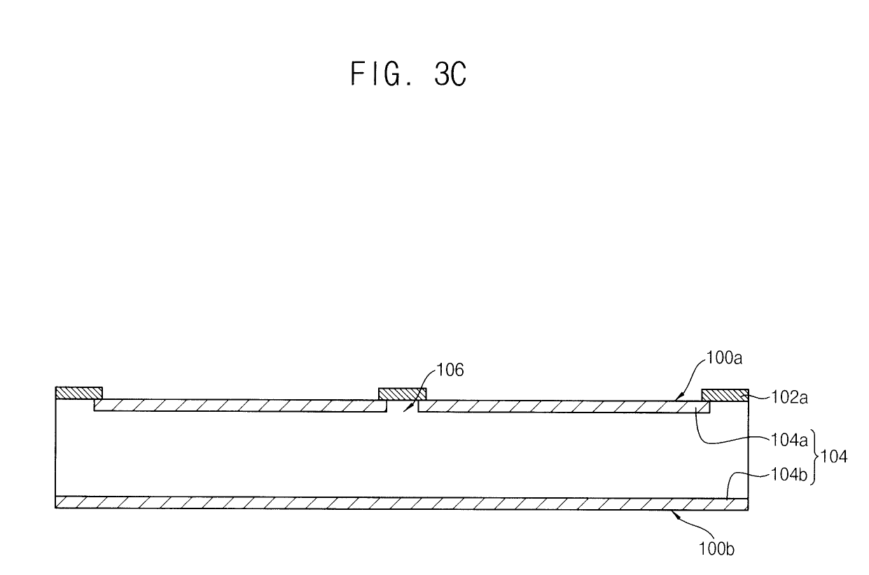

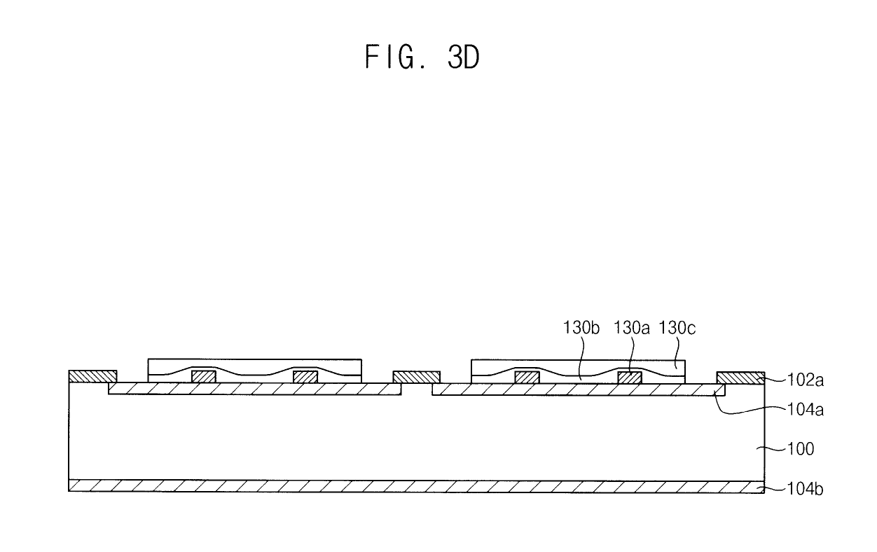

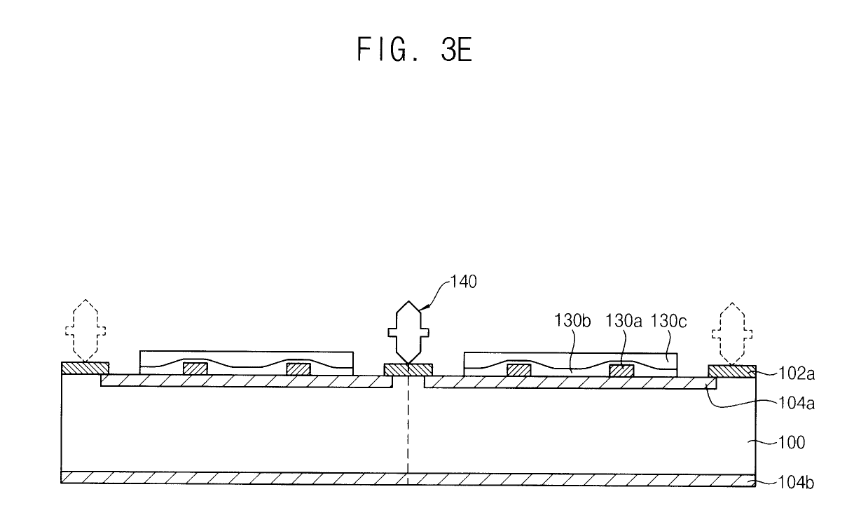

FIGS. 3A to 3E are cross-sectional views illustrating an exemplary embodiment of a method of manufacturing the glass substrate for a display device of FIGS. 1 and 2.

Referring to FIG. 3A, a mother glass plate 100 is provided. The mother glass plate 100 may include glass including soda lime material, a soda lime glass, etc. In one exemplary embodiment, for example, the mother glass plate 100 may be the Gorilla® glass (trade name, available from Corning Incorporated, U.S.A.) having a hardness higher than that of a glass including soda lime material.

The mother glass plate 100 includes a panel area and a scribe line area. A display panel of a display device is formed in the panel area. The mother glass plate 100 may be cut in the scribe line area. The mother glass plate 100 may include a plurality of panel areas and/or a plurality of scribe line areas.

A protection film 102 is formed on the mother glass plate 100 to reduce or effectively prevent ion exchange during chemical strengthening, and to function as a buffer during a cutting operation thereby protecting the mother glass plate 100. The protection film 102 may include an inorganic insulating layer, a metal layer, etc. The protection film 102 is used to form the protection film pattern 102a. The final form of the protection film pattern 102a protects the glass plate 101 from being damaged, and reduces or effectively prevents corrosion or erosion of elements within a structure including the cut glass plate 101. The protection film 102a may include a material having various characteristics such as being eco-friendly, pollution resistant, bleach resistant, etc.

The protection film 102 may include silicon nitride, silicon oxide, aluminum oxide, molybdenum, an alloy of molybdenum-tungsten, etc. The silicon nitride, silicon oxide and aluminum oxide may be deposited on the mother glass plate 100 by chemical vapor deposition, but is not limited thereto or thereby. Also, the molybdenum and an alloy of molybdenum-tungsten may be deposited on the mother glass plate 100 by physical vapor deposition, but is not limited thereto or thereby. In one exemplary embodiment, the protection film 102 may include silicon nitride or silicon oxide.

Where the protection film 102 has a thickness less than about 1,000 Å, it is difficult to prevent ion exchange. Also, where the protection film 102 has a thickness more than about 10,000 Å, the mother glass plate 100 may be difficult to cut. Therefore, the protection film 102 may have a thickness d1 of about 1,000 Å to about 10,000 Å.

Referring to FIG. 3B, the protection film pattern 102a is formed by patterning, such as via photo etching, the protection film 102 on the mother glass plate 100. The protection film pattern 102a may be disposed on and overlapping the scribe line area of the mother glass plate 100.

The etching includes dry etching and/or wet etching. A type of the etching may depend on a material used as the protection film 102. In one exemplary embodiment, for example, the silicon nitride, silicon oxide or aluminum oxide may be patterned by dry etching. When the silicon nitride, silicon oxide or aluminum oxide are etched using wet etching, the mother glass plate 100 may be damaged during the wet etching. On the other hand, the molybdenum or an alloy of molybdenum-tungsten may be patterned by wet etching.

Where a width of the protection film pattern 102a is formed to be smaller than a cutting margin of a wheel used in a cutting operation, a portion of the mother glass plate 100 not overlapping the protection film pattern 102a may be undesirably cut in subsequent processes, such as the cutting operation. Therefore, a width of the protection film pattern 102a may be greater than a cutting margin of the cutting wheel. In one exemplary embodiment, for example, the protection film pattern 102a may have a width W1 of about 5 microns (μm) to about 10 μm.

Referring to FIG. 3C, a portion of the mother glass plate 100 having the protection film pattern 102a thereon, is chemically strengthened. The chemical strengthening includes a soaking operation to substitute atoms of a small ion radius in the mother glass plate 100 with atoms of a large ion radius. In one exemplary embodiment, for example, the chemical strengthening includes exchanging ions on the surface of the mother glass plate 100 via soaking the mother glass plate 100 in a relatively high temperature chemical strengthening treating fluid.

FIG. 4 is a perspective view illustrating an exemplary embodiment of a chemically strengthened mother glass plate 100 including the protection film pattern 102a thereon.

The chemically strengthening may include the following processes, but is not limited thereto or thereby. The mother glass plate 100 is soaked in molten salt of potassium nitrate (KNO3) solution at a temperature of about 400 degrees Celsius (° C.) to about 450° C. for about 30 minutes to about 2 hours. The condition of the chemically strengthening may be variously changed, such as by adjusting the temperature and/or the time of soaking. Thus, once the mother glass plate 100 is soaked in the molten salt solution, alkali ions (e.g., sodium ions) having a small ion radius in the mother glass plate 100 are substituted with potassium ions in the potassium nitrate so that potassium ions having large ion radius are doped on a surface of the mother glass plate 100. A chemically strengthened portion 104 includes first and second chemically strengthened patterns 104a and 104b formed adjacent to upper and lower surfaces 100a and 100b of the mother glass plate 100. Therefore, the upper and lower surfaces 100a and 100b of the mother glass plate 100 are effectively strengthened by generation of compressive stress at an interior of the surface of the mother glass plate 100.

However, the ion exchange is not performed on a portion of the surface of the mother glass plate 100 which overlaps the protection film pattern 102a. Thus, diffusion and impregnation of alkali ions is reduced or effectively prevented on the portion of the surface of the mother glass plate 100 under the protection film pattern 102a, due to the protection film pattern 102a. Therefore, the surface of the mother glass plate 100 disposed under the protection film pattern 102a is not strengthened, thereby forming the non-strengthened portion 106.

Once performing the above processes, the first chemically strengthened portion 104a is formed under the upper surface 100a of the mother glass plate 100, and the second chemically strengthened portion 104b is formed under the lower surface 100b of the mother glass plate 100, where as used herein, “under” may mean toward an interior of the mother glass plate 100 from the respective surface. Also, the non-strengthened portion 106 of the mother glass plate 100 is formed under the protection film pattern 102a.

Also, a potassium ion concentration of the first and second chemically strengthened portion 104a and 104b is higher than that of the non-strengthened portion 106.

Referring to FIG. 3D, a circuit pattern is formed on an upper surface of the first chemically strengthened portion 104a of the mother glass plate 100. The circuit pattern may include a sensing pattern 130a, an insulating layer 130b and an earth electrode layer 130c, but is not limited thereto or thereby. In one exemplary embodiment, for example, the sensing pattern 130a may be formed by depositing a transparent electrode layer on the mother glass plate 100 and patterning the transparent electrode layer. As another exemplary embodiment, the circuit pattern may be formed by attaching a film including a sensing pattern 130a, an insulating layer 130b and an earth electrode layer 130c on the upper surface of the first chemically strengthened portion 104a of the mother glass plate 100. In this case, the film including the sensing pattern 130a, the insulating layer 130b and the earth electrode layer 130c may be formed separately from the mother glass plate 100 and then subsequently provided on the mother glass plate 100.

The circuit pattern may be formed after the chemical strengthening, but is not limited thereto or thereby, and may be formed through a different sequence of operations. Alternatively, the circuit pattern may be formed after the mother glass plate 100 is cut in a cutting operation.

Alternatively, the circuit pattern may be omitted so that the circuit pattern is not formed on the mother glass plate 100.

Referring to FIG. 3E, the mother glass plate 100 is cut at the protection film pattern 102a, such as by a cutting wheel. The cutting is performed while the protection film pattern 102a is on the mother glass plate 100. Therefore, as shown in FIG. 2, a cut glass plate 101 is formed in a designed size from the mother glass plate 100, so that the glass substrate for a display device is completed.

In one exemplary embodiment, a scroll wheel 140 of a piece of wheel cutting equipment contacts the protection film pattern 102a at a substantially constant speed, so that a crack is generated on the surface of the protection film pattern 102a and the lower mother glass plate 100. In the case of using the scroll wheel 140, a crack is generated to a depth of several tens of μm, so that the crack may be extended downward in a thickness direction of the mother glass plate 100 and the protection film pattern 102a, to at least the upper surface 100a of the mother glass plate 100 under the protection film pattern 102a. With the crack extended to the mother glass plate 100, a force is applied to the mother glass plate 100 is cut such as by downwardly pressing the cracked mother glass plate 100 in a location proximate to the crack.

Thus, a double layer including the protection film pattern 102a and the mother glass plate 100 is cut by a single cutting wheel. When the double layer is cut, a crack generated in a direction other than thickness direction may be decreased compared to a cutting operation for a single-layered glass plate. Also, chipping of an edge of the glass plate may be decreased.

When the surface of the mother glass plate 100 is chemically strengthened, the mother glass plate 100 may not be easily separated such as by a cutting wheel due to high surface hardness. However, when the surface of the mother glass plate 100 is chemically strengthened, a compressive stress exists on the surface of the chemically strengthened mother glass plate 100 and a tensile stress exists at the non-strengthened interior of the mother glass plate 100. Due to the compressive stress on the surface of the mother glass plate 100, a crack used in separating the mother glass plate 100 is not formed in a constant direction but instead is generated in various directions during a cutting operation using the cutting wheel. Thus, since the crack is undesirably formed in various directions, a high cost laser may be used to separate the chemically strengthened mother glass plate instead of a lower cost cutting wheel.

However, in one or more exemplary embodiment of the invention, a portion of the mother glass plate 100 which is under the protection film pattern 102a is not chemically strengthened. Thus, the crack used in separating the mother glass plate 100 may be easily formed by a low cost cutting wheel, so that the mother glass plate 100 may be separated without damage thereto. Additionally, a cost for cutting the mother glass plate 100 may be reduced and productivity can be increased.

Although not shown in FIGS. 1 to 4, the edge of the glass substrate for a display device may be polished such as by a chamfer process. The chamfer process is performed to remove a residual crack at the edge of the cut glass plate 101, generated by the cutting wheel.

FIG. 5 is a cross-sectional view illustrating another exemplary embodiment of a glass substrate for a display device according to the invention.

As shown in FIG. 5, the glass substrate of FIG. 5 is a modification of the glass substrate of FIGS. 1 to 4, and includes a chemically strengthened glass plate 101. Unlike the glass substrate of FIGS. 1 to 4, the glass substrate of FIG. 5 does not include a protection film pattern on the edge of the upper surface 100a of a finally completed glass substrate for a display device. Also, an entire of the upper and lower surfaces 100a and 110b of the glass plate 101 in FIG. 5 is chemically strengthened, so that the glass plate 101 does not include a non-strengthened portion.

An exemplary embodiment of a method of manufacturing the glass substrate for a display device shown in FIG. 5 is hereinafter described.

The same processes of FIGS. 3A to 3D is performed. In the process of polishing the edge of the glass plate 101 separated from the mother glass plate 100, the polishing may be performed to additionally remove the protection film pattern 102a entirely. In this case, the protection film pattern 102a does not remain on the finally formed glass substrate for a display device.

When performing the process as described above, since an area corresponding to the non-strengthened portion is entirely removed, the entire upper and lower surfaces 100a and 100b of the completed glass plate 101 are chemically strengthened.

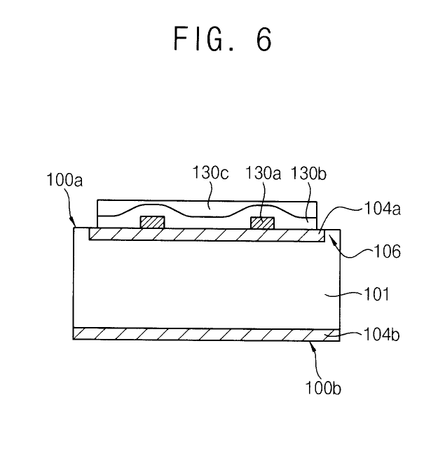

FIG. 6 is a cross-sectional view illustrating still another exemplary embodiment of a glass substrate for a display device according to the invention.

As shown in FIG. 6, the glass substrate of FIG. 6 is a modification of the glass substrate of FIGS. 1 to 4, and includes a chemically strengthened glass plate 101. Unlike the glass substrate of FIGS. 1 to 4, the glass substrate of FIG. 6 does not include the protection film pattern on the edge of the upper surface 100a of a finally completed glass plate for a display device. Also, the glass plate 101 includes a non-strengthened portion 106 on the edge of the upper surface 100a of the glass plate 101.

An exemplary embodiment of a method of manufacturing the glass substrate for a display device shown in FIG. 6 is hereinafter described.

The same process of FIGS. 3A to 3E is performed. The protection film pattern 102a which remains at the edge of the glass plate 101 which is separated from the mother glass plate 100 is removed.

The protection film pattern 102a may be removed such as by a separate etching operation. After the protection film pattern 102a is removed, the non-strengthened portion 106 may remain on at the upper surface edge of a finally formed glass substrate for a display device.

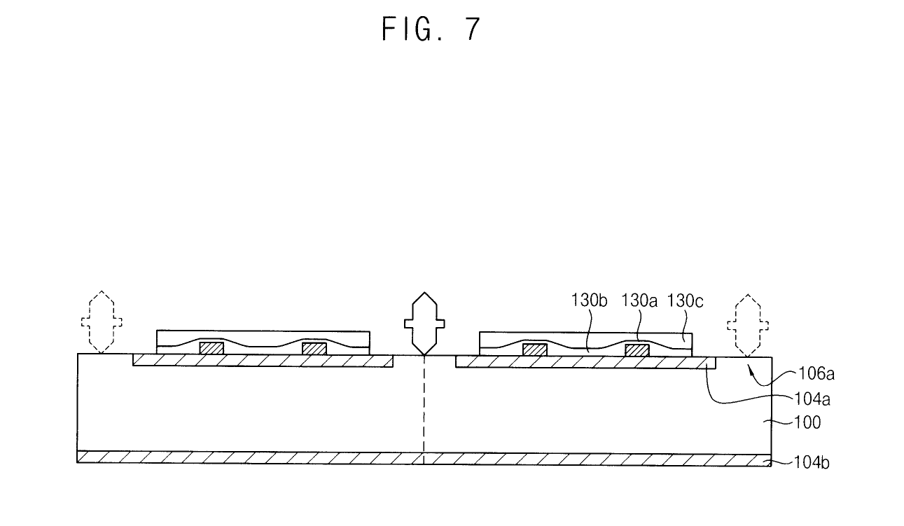

FIG. 7 is a cross-sectional view illustrating another exemplary embodiment of a method of manufacturing the glass substrate for a display device of FIG. 6.

Alternatively, the mother glass plate 100 is chemically strengthened by process described with reference to FIGS. 3A to 3C.

A circuit pattern is formed on the upper surface of the first chemically strengthened portion 104a of the mother glass plate 100. The circuit pattern may be formed by depositing and patterning an electrode layer on the mother glass plate 100. As another exemplary embodiment, the circuit pattern may be formed by affixing a film including circuit elements and wiring to the upper surface of the first chemically strengthened portion 104a of the mother glass plate 100.

After the circuit pattern is formed, the protection film pattern 102a previously formed on the mother glass plate 100 is removed. Once the protection film pattern 102a is removed, the non-strengthened portion 106a of the mother glass plate 100 is exposed.

In an alternative exemplary embodiment, the order of forming the circuit pattern and removing the protection film pattern 102a may be reversed such that the protection film pattern 102a may be removed before forming the circuit pattern 102a.

Next, as shown in FIG. 7, the mother glass plate 100 is separated by cutting along the exposed non-strengthened portion 160a of the mother glass plate 100 of, and the glass plate 101 is formed. Through the cutting process, the glass substrate for a display device is formed from the mother glass plate 100. The chamfering of the edge of the glass plate 101 may be further performed after separating the glass plate 101. The cutting and the chamfering are the same as described in reference to FIG. 3E.

According to the above method, the mother glass plate 100 is separated by a low cost cutting wheel to form the glass substrate for a display device of FIG. 6.

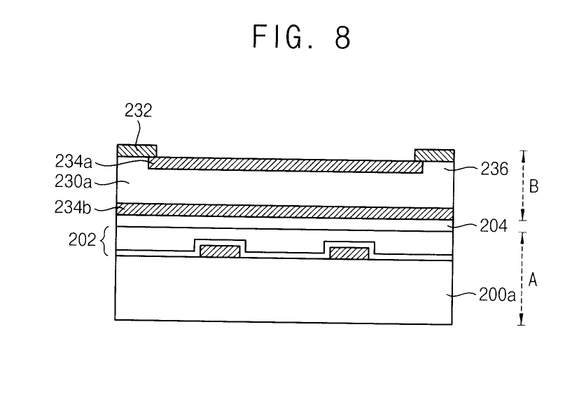

FIG. 8 is a plan view illustrating further still another exemplary embodiment of a glass substrate for a display device according to the invention.

The glass substrate for a display device in FIG. 8 may include a structure where a chemically strengthened glass plate and a non-strengthened glass plate are coupled, such as by bonding.

As shown in FIG. 8, a portion ‘A’ includes a circuit pattern layer 202 including a circuit pattern, on a non-strengthened first glass plate 200a. As used herein, a non-strengthened plate may mean a plate excluding strengthened portions at outer surfaces thereof. The circuit layer pattern 202 may include a plurality of circuit patterns. A circuit pattern layer is not on a chemically strengthened second glass plate 230a in a portion ‘B’. The chemically strengthened second glass plate 230a is coupled to the portion ‘A’ including the non-strengthened first glass plate 200a. A protection film pattern 232 is on the chemically strengthened second glass plate 230a.

Although not shown, in another exemplary embodiment, a shape of the edge of the chemically strengthened second glass plate 230a may be same as the glass plate 101 in FIG. 5 or FIG. 6.

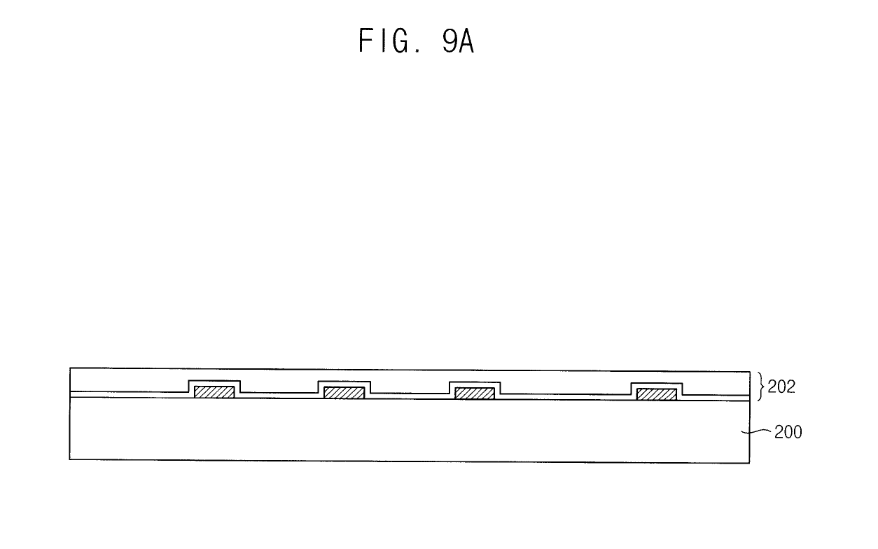

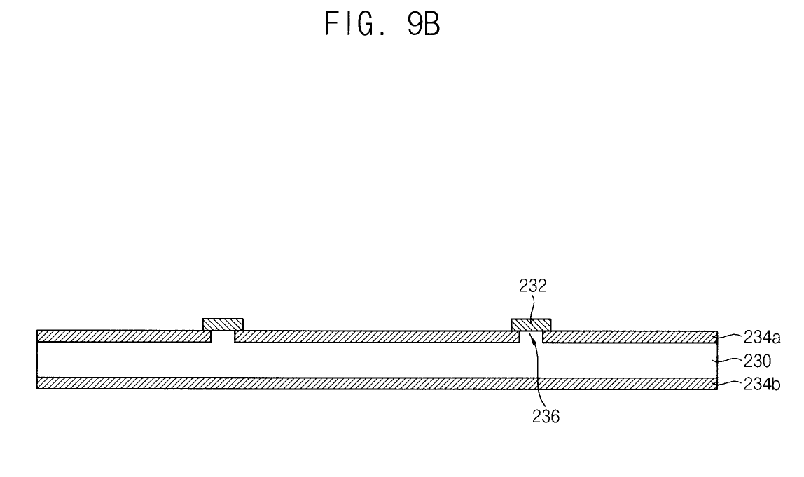

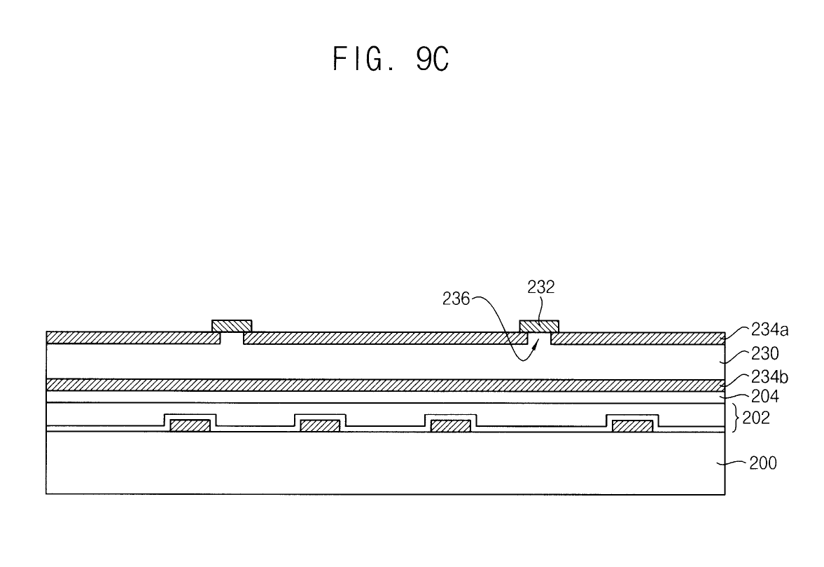

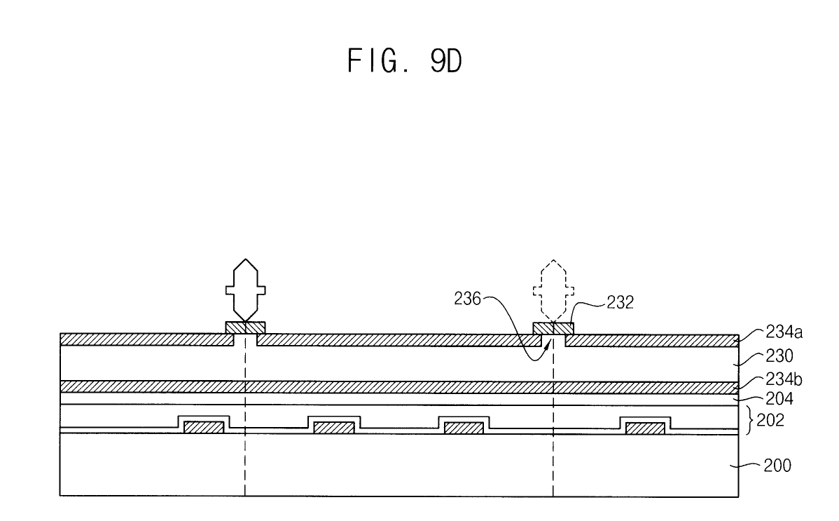

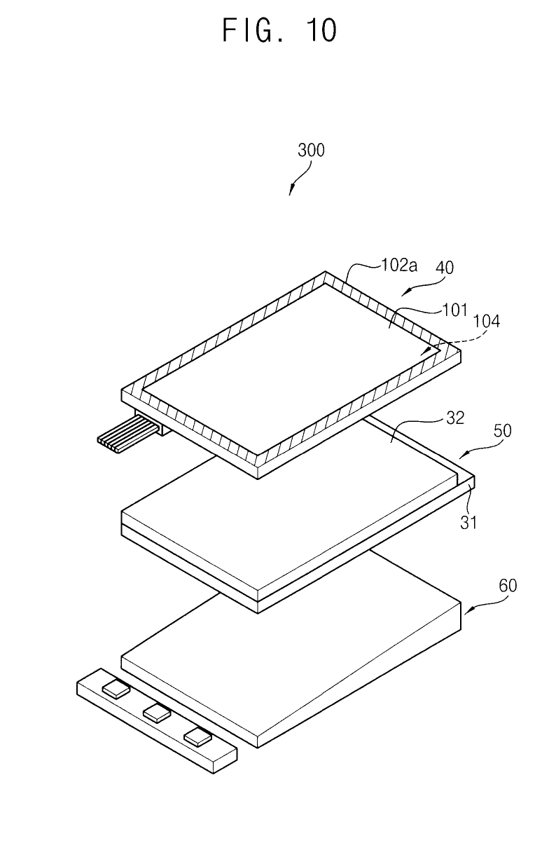

FIGS. 9A to 9D are plan views illustrating an exemplary embodiment of a method of manufacturing the glass substrate for a display device of FIG. 8.

Referring to FIG. 9A, a first mother glass plate 200 is provided. The first mother glass plate 200 may be a non-strengthened glass plate. The first mother glass plate 200 may be a glass including soda lime material, a soda-lime glass. Otherwise, the first mother glass plate 200 may be a Gorilla® glass (trade name, available from Corning Incorporated, U.S.A.) having a hardness greater than the glass including soda lime material.

A circuit pattern layer 202 including a circuit pattern is formed on the first mother glass plate 200. The circuit pattern layer 202 is formed on the second mother glass plate 200 by depositing and patterning an electrode layer on the mother glass plate 200. As another exemplary embodiment, the circuit pattern layer 202 may be formed by affixing a film including circuit elements and wiring to the upper surface of the non-strengthened first mother glass plate 200. The non-strengthened first mother glass plate 200a and the circuit pattern layer 202 may collectively form a first portion.

Referring to FIG. 9B, a protection film pattern 232 is formed on the upper surface of the second mother glass plate 230. The first chemically strengthened portion 234a, the second chemically strengthened portion 234b and a non-strengthened portion 236 are formed by chemically strengthening. The chemically strengthening may be performed by process same as described in referring to FIGS. 3A to 3C. The chemically strengthened first mother glass plate 230 and the protective film pattern 232 may collectively form a second portion.

Referring to FIG. 9C, a surface of the second chemically strengthened portion 234b of the second mother glass plate 230 and the first portion including the circuit pattern layer 202 on the first mother glass plate 200 are coupled to each other. In an exemplary embodiment, the first and second mother glass plates 200 and 230 of the first and second portions, respectively, are coupled by a bonding layer 204 on the first and second mother glass plate 200 and 230 and between the first and second portions.

Referring to FIG. 9D, the bonded first mother glass plate 200 the protection film pattern 232 and the second mother glass plate 230 are separated by cutting, such as by a cutting wheel. Through the cutting, the bonded mother glass plates 200 and 230 are separated, and then, as shown in FIG. 8, a respective glass plate for a display device is formed in designed size.

The wheel cutting is same as described in FIG. 3E.

According to the above method, the bonded mother glass plates 200 and 230 are separated by a low cost cutting, to form the glass plate for a display device of FIG. 8.

The glass plate for display device described above may be used for a touch screen panel, but is not limited thereto or thereby. An exemplary embodiment of a display module including a touch screen panel is described hereinafter.

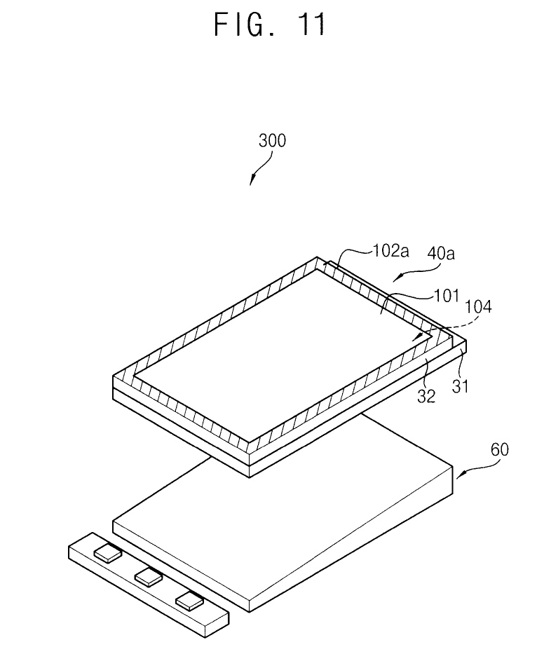

FIG. 10 is an exploded perspective view illustrating an exemplary embodiment of a display module including a glass substrate according to the invention.

Referring to FIG. 10, a display module includes a touch screen panel 40, a display panel 50 and a backlight unit 60. The display panel 50 may be a liquid crystal device (“LCD”) display panel, but is not limited thereto or thereby.

The touch screen panel 40 is an element of the display module generating location signals based on a touch location which is contacted by a user on a touch surface of the touch screen panel 40. The touch screen panel 40 includes a signal pattern for sensing the contact of the user on a chemically strengthened glass plate. The touch screen panel 40 may include the glass plate for a display device detailed in FIGS. 1-4, but the invention is not limited thereto or thereby. Referring to FIGS. 1-4, the circuit pattern on the glass plate is an element of the touch screen panel 40 generating the location signals based on the touch location contacted by the user.

Also, referring to FIGS. 3A to 3E, an exemplary embodiment of a method of manufacturing the touch screen panel 40 may include forming the protection film pattern 102a and performing a separating operation such as using a cutting wheel.

The LCD panel 50 includes a first substrate 31 such as a thin film transistor substrate including a thin film transistor connected to a pixel electrode, a second substrate 32 including a color filter expressing a prescribed color by light passing therethrough, and LCD driver (not shown) for driving the thin film transistor. The first and second substrates 31 and 32 have be bonded to each other.

Also, the touch screen panel 40 and the LCD panel 50 are coupled to each other such as by a bonding layer (not shown).

The back light unit 60 is a light source which generates and provides light to LCD panel 50.

Although not shown, a mold frame may be provided. The mold frame combines the touch screen panel 40, the LCD panel 50 and back light unit 60 facing each other and at the same time supports these elements.

The touch screen panel 40 of the display module 300 is formed by a low cost cutting wheel, such as described in one or more exemplary embodiments above. Therefore, the display module 300 may be manufactured at a low cost and have high strength owing to the strengthened mother glass plate within the touch screen panel and/or other elements of the display module 300.

FIG. 11 is an exploded perspective view illustrating another exemplary embodiment of a display module including a glass substrate according to the invention.

Referring to FIG. 11, a display module 301 includes an integrated touch screen panel 40a combined with LCD panel, and a back light unit 60.

The integrated touch screen panel 40a includes a first substrate 31 such as a thin film transistor substrate including a thin film transistor connected with a pixel electrode, and a second substrate 32 including a color filter and a circuit pattern driven by signals generated by a user's touch. The first substrate 31 and the second substrate 32 are parallel to and facing to each other. A liquid crystal layer (not shown) is between the first substrate 31 and the second substrate 32.

The first substrate 31 includes a non-strengthened glass plate.

The second substrate 32 may include the glass plate described with respect to FIGS. 1-4, but is not limited thereto or thereby. Referring to FIGS. 1-4, the second substrate 32 includes a glass plate 101, and a protection film pattern 102a, on the upper surface of edge of the glass plate 101. The glass plate 101 includes a first chemically strengthened portion 104a, a non-strengthened portion 106 and a second chemically strengthened portion 104b. The first chemically strengthened portion is under an upper surface 100a of the glass plate 101, the non-strengthened portion 106 is on a periphery of the upper surface 100a, and the second chemically strengthened portion 104b is formed under a lower surface 100b of the glass plate 101. The non-strengthened portion 106 is on the glass plate 101 under and overlapping the protection film pattern 102a. The color filter and circuit patterns driven by signals generated by user's touch are on the second chemically strengthened portion 104b of the glass plate 101.

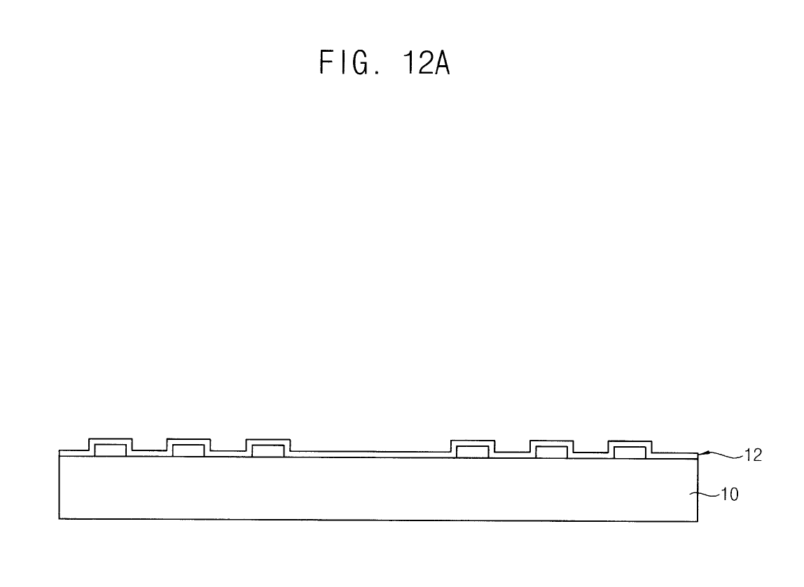

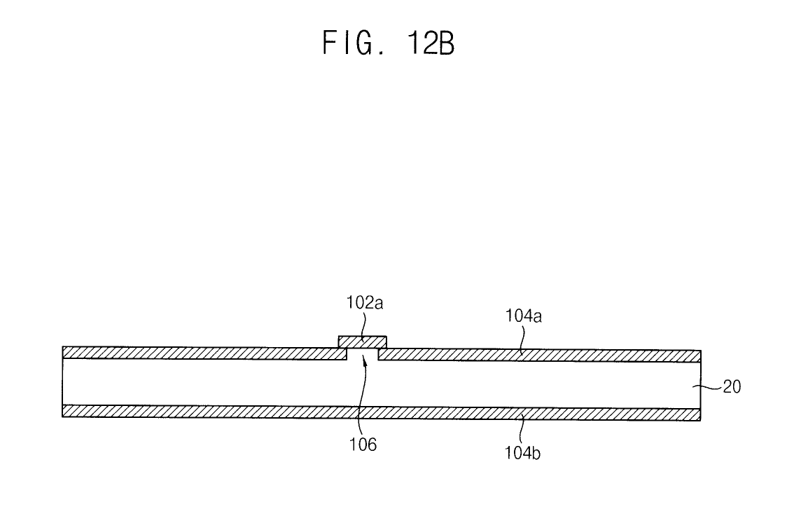

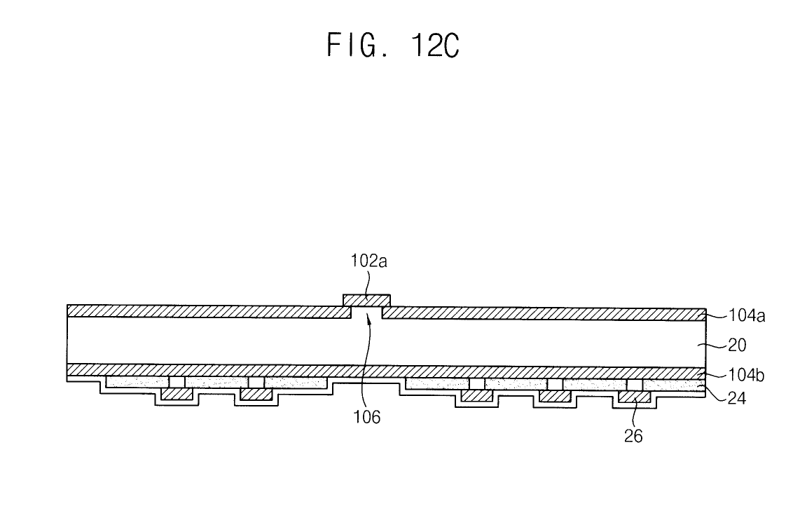

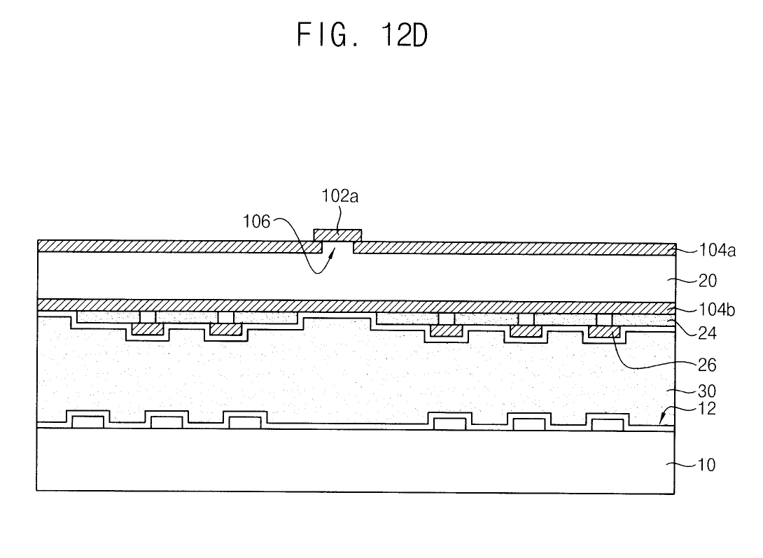

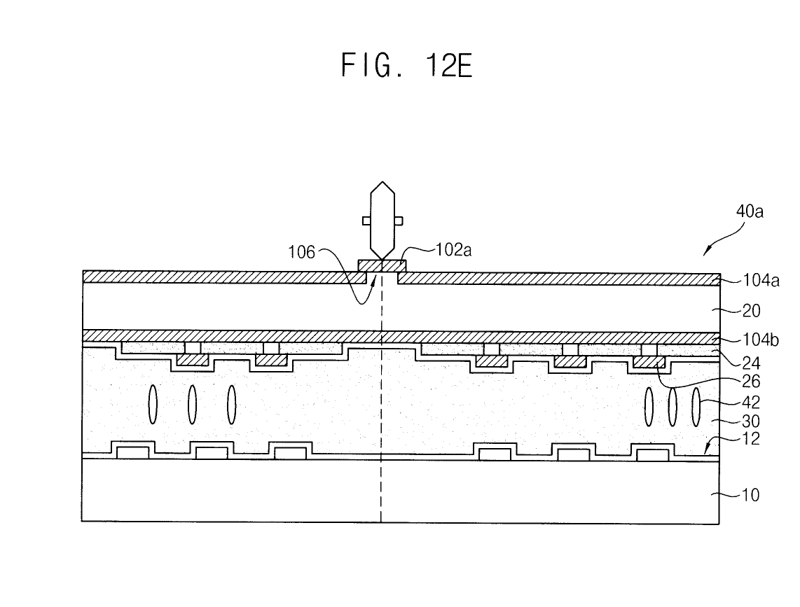

FIGS. 12A to 12E are cross-sectional view illustrating an exemplary embodiment of a method of manufacturing the display module of FIG. 11.

Referring to FIG. 12A, a first mother glass plate 10 is provided. The first mother glass plate 10 may be a non-strengthened glass plate. A thin film transistor for providing signals to the LCD panel, and a pixel electrode 12 are formed on the first mother glass plate 10. The first mother glass plate 10 including the thin transistor and the pixel electrode 12 may collectively form a first portion.

Referring to FIG. 12B, a second mother glass plate 20 is provided. The process as described referring to FIGS. 3A to 3C is performed, and then, a chemically strengthened glass plate is formed according to one or more of the above-described embodiments of a glass plate of a display device. In on exemplary embodiment, for example, the chemically strengthened glass plate includes a first chemically strengthened portion 104a, a second chemically strengthened portion 104b and a non-strengthened portion 106.

Referring to FIG. 12C, a circuit pattern layer 24 including one or more circuit patterns is formed on a surface of the second chemically strengthened portion 104b of the chemically strengthened second mother glass plate 20. The circuit patterns of the circuit pattern layer 24 are elements generating location signals based on a touch location contacted by a user. The circuit patterns of the circuit pattern layer 24 include transparent electrode.

A black matrix (not shown) and a color filter 26 are formed on the circuit pattern layer 24. The black matrix is formed corresponding to a respective pixel area and a thin film transistor, and the color filter is formed corresponding to a respective pixel area. The second mother glass plate 20 including the circuit pattern layer 24, the black matrix and the color filter 26 may collectively form a second portion.

Referring to FIG. 12D, the first and second mother glass plates 10 and 20 of the first and second portions are coupled. In an exemplary embodiment, a bonding layer 30 is provided between the first mother glass plate 10 and the second mother glass plate 20. At this time, an upper surface of the first portion including the first mother glass plate 10 and a periphery of the second chemically strengthened portion 104b of the second portion including the second mother glass plate 20 are bonded to each other.

Referring to FIG. 12E, in the bonded first and second portions including the first and second mother glass plates 10 and 20, a periphery of the protection film pattern 102a of the second mother glass plate 20 is separated such as by a cutting wheel. That is, the separation by the cutting wheel is performed while the protection film pattern 102a remains on the second mother glass plate 20. Through the cutting process, portions of the bonded first and second mother glass plate 10 and 20 are separated, and a glass plate of designed size is achieved. The cutting operations may be the same as described in FIG. 3E.

Liquid crystal 42 is injected into the separated glass plate and a liquid crystal layer is formed. With this, the integrated touch screen panel 40a combined with LCD panel is completed.

Also, although not shown, the integrated touch screen panel 40a and a backlight unit 60 are combined by upper and lower mold frames, and then, the display module 301 shown in FIG. 11 may be completed.

According to the above method, the bonded mother glass plates 10 and 20 are separated by a low cost cutting wheel, and then the display module 301 of FIG. 11.

Chemically strengthened glass samples were compared.

A following test was performed to identify whether a chemical strengthening treatment was performed to a portion of glass plate under a protection film pattern. Samples according to an exemplary embodiment of the invention, and a comparison sample were prepared for testing as described below.

Sample 1 to 4 is a strengthened glass manufactured by the exemplary embodiment of a method of manufacturing a glass plate with reference to FIGS. 3A to 3C, and material of a protection film pattern and thickness of a protection film pattern are different.

The comparison sample did not include a protection film pattern and is a chemically strengthened glass by soaking. The table below details the type of glass, the material of the protection film pattern, a thickness of the protection film pattern in Å and a thickness of the strengthened portion in μm for each of the samples and the comparison sample.

| | | Material of a | thickness of a | thickness of a |
|---|---|---|---|---|
| | | protection film | protection film | strengthened |
| | A type of glass | pattern | pattern | portion |
| sample 1 | A glass including | silicon nitride | 1000 Å | 10 to 20 μm |
| | soda lime material | | | |
| sample 2 | A glass including | silicon nitride | 2000 Å | 10 to 20 μm |
| | soda lime material | | | |
| sample 3 | A glass including | silicon oxide | 1000 Å | 10 to 20 μm |
| | soda lime material | | | |
| sample 4 | A glass including | silicon oxide | 2000 Å | 10 to 20 μm |
| | soda lime material | | | |
| comparison | A glass including | none | none | 10 to 20 μm |
| sample 1 | soda lime material | | | |

When the glass plate is chemically strengthened by soaking as described referring to FIG. 3C, Alkaline ions (e.g., sodium ion) of the glass plate are substituted with potassium ions. Therefore, a potassium ion concentration of a portion of the chemically strengthened glass plate is increased by doping of potassium ions and sodium ion concentration is decreased. On the other hand, ion exchange substantially does not occur at the surface of the glass plate under the protection film pattern, so that a chemically strengthening is not performed. Therefore, potassium ion is not doped at the surface of the glass plate under the protection film pattern, so that potassium ion concentration is low and sodium ion concentration is relatively high. Therefore, the lower portion of the protection film pattern is not chemically strengthened, so that the test identified whether a chemically strengthening treatment was performed to the portion of glass plate under a protection film pattern by measurement a content of a potassium ion and a sodium ion.

Results of the test are provided in the following table.

A content of a potassium ion and a sodium ion of a portion of the glass plate under the protection film pattern is respectively investigated in the each sample.

| | Component of | Component of |
|---|---|---|
| | sodium (Wt %) | potassium (Wt %) |
| sample 1 | 6.73 | 0 |
| sample 2 | 5.62 | 1.41 |
| sample 3 | 1.72 | 0 |
| sample 4 | 6.43 | 1.33 |
| comparison sample 1 | 2.07 | 8.04 |

As shown in the above result, a potassium ion was not detected or a potassium ion concentration was low in the samples 1 to 4. As a result, it is determined that a chemically strengthening is not performed at the portion of the glass plate under the protection film pattern. Therefore, the portion of the protection film pattern under the protection film pattern has a relatively weak hardness, so that separating a glass plate at the portion of glass plate under the protection film pattern, such as by cutting, was identified.

Although a few exemplary embodiments of the invention have been described, those skilled in the art will readily appreciate that many modifications are possible in the exemplary embodiments without materially departing from the novel teachings and advantages of the invention.

What is claimed is:

1. A glass substrate for a display device, comprising:
a glass plate comprising:
a first chemically strengthened portion on an upper surface of the glass plate;
a non-strengthened portion on a periphery of the upper surface of the glass plate;
a second chemically strengthened portion on a lower surface of the glass plate; and
a protection film pattern on the non-strengthened portion of the glass plate.

2. The glass substrate of claim 1, wherein the protection film pattern comprises at least one selected from silicon nitride, silicon oxide, aluminum oxide, molybdenum and an alloy of molybdenum-tungsten.

3. The glass substrate of claim 1, wherein the protection film pattern has a thickness of about 1,000 angstroms to about 10,000 angstroms.

4. A method of manufacturing a glass plate for a display device, the method comprising:
forming a protection film on a mother glass plate;
patterning the protection film to form a protection film pattern, wherein the protection film pattern prevents ion exchange;
chemically strengthening the mother glass plate by exchanging alkaline ions of the mother glass plate including the protection film pattern with metal ions of a molten salt, to form a first chemically strengthened portion on an upper surface of the mother glass plate, a non-strengthened portion on a portion of the mother glass plate under the protection film pattern and a second chemically strengthened portion on a lower surface of the mother glass plate; and
cutting an upper surface of the protection film pattern to separate the glass plate at the non-strengthened portion of the mother glass plate, from the mother glass plate.

5. The method of claim 4, wherein the protection film pattern comprises at least one selected from silicon nitride, silicon oxide, aluminum oxide, molybdenum and an alloy of molybdenum-tungsten.

6. The method of claim 5, wherein
the protection film comprises at least one selected from silicon nitride, silicon oxide and aluminum oxide; and
the forming the protection film pattern comprises dry etching the protection film to form the protection film pattern.

7. The method of claim 5, wherein
the protection film comprises at least one selected from molybdenum and an alloy of molybdenum-tungsten; and
the forming the protection film pattern comprises wet etching the protection film to form the protection film pattern.

8. The method of claim 4, wherein the protection film pattern is formed to have a thickness of about 1,000 angstroms to about 10,000 angstroms.

9. The method of claim 4, wherein
the cutting an upper surface of the protection film pattern is performed in a cutting margin, and
a width of the protection film pattern is greater than the cutting margin.

10. The method of claim 4, wherein
the molten salt comprises a salt of potassium nitrate; and
the chemical strengthening the mother glass plate further comprises:
soaking the mother glass plate including the protection film pattern in the molten salt at a temperature of about 400 degrees Celsius to about 450 degrees Celsius for about 30 minutes to about 2 hours, to form a compressive stress layer on the upper and lower surfaces of the mother glass plate, wherein the compressive stress layer is formed by exchanging alkaline ions of the mother glass plate with potassium ions of the molten salt.

11. The method of claim 10, wherein a potassium ion concentration of the first and second chemically strengthened portions of the mother glass plate is higher than a potassium ion concentration of the non-strengthened portion of the mother glass plate.

12. The method of claim 4, further comprising:
forming a circuit pattern including a sensing pattern, on the upper surface of the chemically strengthened mother glass plate.

13. The method of claim 4, wherein the cutting an upper surface of protection film pattern is performed through a wheel cutting process.

14. The method of claim 13, wherein the wheel cutting process comprises:
moving a scroll wheel onto the protection film pattern to generate a crack on the mother glass plate; and
applying a force to the cracked mother glass plate to separate the glass plate from the mother glass plate.

15. The method of claim 4, further comprising polishing an edge of the separated glass plate to remove a residual crack at the edge of the separated glass plate, after the cutting an upper surface of the protection film pattern.

16. The method of claim 15, wherein the polishing an edge of the separated glass removes an entire of the protection film pattern.

17. A method of manufacturing a glass plate for a display device, the method comprising:
forming a first mother glass plate comprising a circuit pattern;
forming a protection film on a second mother glass plate;
patterning the protection film to form a protection film pattern, wherein the protection film pattern prevents ion exchange;
chemically strengthening the second mother glass plate by exchanging alkaline ions of the second mother glass plate including the protection film pattern with metal ions of a molten salt to form a first chemically strengthened portion on an upper surface of the mother glass plate, a non-strengthened portion on a lower surface of the protection film pattern and a second chemically strengthened portion on a lower surface of the mother glass plate;
combining the second chemically strengthened portion of the second mother glass plate and an upper surface of the first mother glass plate, to form a laminated glass plate; and
cutting an upper surface of protection film pattern of the second mother glass plate to separate the first and second mother glass plates at the non-strengthened portion of the second mother glass plate, from the laminated glass plate.

18. The method of claim 17, wherein the protection film comprises at least one selected from silicon nitride, silicon oxide, aluminum oxide, molybdenum and an alloy of molybdenum-tungsten.

19. The method of claim 17, wherein the protection film is formed to have a thickness of about 1,000 angstroms to about 10,000 angstroms.

20. The method of claim 17, wherein the cutting an upper surface of protection film pattern is performed through a wheel cutting process.
